(19) United States
(12) Patent Application Publication
(10) Pub. No.: US 2026/0241746 A1
(43) Pub. Date: Aug. 20, 2026

(54) TIRE TREAD

(71) Applicant: Beyond Lotus LLC, Wilmington, DE (US)

(72) Inventors: Michael Beaulieu, Bolton, MA (US); Ping Zhang, Westford, MA (US); Geoffrey D. Moeser, Groton, MA (US); Jincheng Xiong, Boxborough, MA (US); Dhaval A. Doshi, Lexington, MA (US)

(21) Appl. No.: 19/164,459

(22) PCT Filed: Mar. 13, 2024
(86) PCT No.: PCT/US2024/019657

§ 371 Date: Sep. 11, 2025

Related U.S. Application Data
(60) Provisional application No. 63/490,399, filed on Mar. 15, 2023.
(60) Provisional application No. 63/490,401, filed on Mar. 15, 2023.

(51) Int. Cl. B60C 1/00; C08K 3/04; C08K 3/22; C08K 3/36

(52) U.S. Cl. CPC B60C 1/0016; C08K 3/04; C08K 3/22; C08K 3/36; C08K 2003/2296; C08K 2201/006

(57) ABSTRACT

Disclosed herein are treads comprising at least one elastomer and at least 15 phr silica, wherein the tread has a low total concentration of defects arising from particles (e.g., silica, carbon black) and/or voids.

### FIELD OF THE INVENTION

Disclosed herein are silica-containing tire treads having low defect concentration.

### BACKGROUND

Numerous products of commercial significance are formed of elastomeric compositions wherein reinforcing filler is dispersed in one or more elastomers, such as synthetic elastomers, natural rubber, or blends of such elastomers. A composite or masterbatch formed by mixing the reinforcing filler with the elastomer(s) is then compounded with processing and curing additives. Various products are generated upon curing including, for example, pneumatic and non-pneumatic or solid tires for vehicles, such as the tread portion including cap and base and undertread.

Carbon black is often used as a reinforcing filler for rubber compounds incorporated into tires, e.g., incorporated as tire treads. Silica is also commonly used in tire applications and can offer certain performance benefits over carbon black-based tire treads, such as improved rolling resistance. However, there is a trade-off with silica-based compounds in that such compounds exhibit poorer wear performance, e.g., for natural rubber-containing compounds. Therefore, there is a need to provide silica-containing rubber compounds that can optimize both wear and rolling resistance properties.

### SUMMARY

One aspect is a tire tread comprising at least one elastomer and at least 15 phr of silica, wherein the tread has a low total defect concentration indicated by a value A_{T}, defined as an area percentage of defects of a 1-μm thick rubber slice, satisfying at least one of (i) to (vi):
(i) A_{T}≤2.7% for defects having an area-equivalent diameter of at least 2 μm;
(ii) A_{T}≤1.4% for defects having an area-equivalent diameter of at least 3 μm;
(iii) A_{T}≤0.75% for defects having an area-equivalent diameter of at least 4 μm;
(iv) A_{T}≤0.5% for defects having an area-equivalent diameter of at least 5 μm;
(v) A_{T}≤0.33% for defects having an area-equivalent diameter of at least 6 μm; and
(vi) A_{T}≤0.15% for defects having an area-equivalent diameter of at least 10 μm.

Another aspect is a tire tread comprising at least one elastomer and at least 15 phr of silica wherein the tread has a low total defect concentration indicated by a value N_{T}, defined as number of defects per area of a 1-μm thick rubber slice, satisfying at least one of (i) to (vi):
(i) N_{T}≤1700/mm² for defects having an area-equivalent diameter of at least 2 μm;
(ii) N_{T}≤950/mm² for defects having an area-equivalent diameter of at least 3 μm;
(iii) N_{T}≤250/mm² for defects having an area-equivalent diameter of at least 4 μm;
(iv) N_{T}≤100/mm² for defects having an area-equivalent diameter of at least 5 μm; and
(v) N_{T}≤50/mm² for defects having an area-equivalent diameter of at least 6 μm.

Another aspect is a tread comprising at least one elastomer and at least 15 phr of at least one silica, wherein the tread has a low voids concentration indicated by a value A_{V}, defined as an area percentage of voids of a 1-μm thick rubber slice, satisfying at least one of (i) to (vi):
(i) A_{V}≤0.6% for voids having an area-equivalent diameter of at least 2 μm; and
(ii) A_{V}≤0.4% for voids having an area-equivalent diameter of at least 3 μm.

Another aspect is a tread comprising at least one elastomer and at least 15 phr of at least one silica, wherein the tread has a low voids concentration indicated by a value N_{V}, defined as number of voids per area of a 1-μm thick rubber slice, satisfying at least one of (i) to (vi):
(i) N_{V}≤500/mm² for voids having an area-equivalent diameter of at least 2 μm;
(ii) N_{V}≤150/mm² for voids having an area-equivalent diameter of at least 3 μm; and
(iii) N_{V}≤65/mm² for voids having an area-equivalent diameter of at least 4 μm.

Another aspect is a tire tread comprising at least one elastomer and at least 15 phr silica, wherein the tread has a low total defect concentration as indicated by the equation

$${A}_{T} \leq a \cdot {e}^{- bx} + c$$

wherein x=silica loading (phr) and A_{T} is an area percentage of defects in a 1 μm thick tread slice and satisfies at least one of (i) to (v):
(i) a=4, b=0.08, and c=1.9 for defects having an area-equivalent diameter of at least 2 μm;
(ii) a=2.4, b=0.07, and c=1 for defects having an area-equivalent diameter of at least 3 μm;
(iii) a=0.8, b=0.008, and c=0.09 for defects having an area-equivalent diameter of at least 4 μm;
(iv) a=−0.73, b=0.15, and c=0.93 for defects having an area-equivalent diameter of at least 5 μm; and
(v) a=−5.26, b=0.001, and c=5.38 for defects having an area-equivalent diameter of at least 6 μm.

Another aspect is a tire tread comprising at least one elastomer and at least 15 phr silica, wherein the tread has a low total defect concentration as indicated by the equation

$${N}_{T} \leq a \cdot {e}^{- bx} + c$$

wherein x=silica loading (phr) and N_{T} is a number of defects per area in a 1 μm thick tread slice and satisfies at least one of (i) to (v):
(i) a=2500, b=0.007, and c=0 for defects having an area-equivalent diameter of at least 2 μm;
(ii) a=1500, b=0.018, and c=0 for defects having an area-equivalent diameter of at least 3 μm;
(iii) a=580, b=0.14, and c=240 for defects having an area-equivalent diameter of at least 4 μm;
(iv) a=−30, b=0.01, and c=120 for defects having an area-equivalent diameter of at least 5 μm; and
(v) a=−590, b=0.0014, and c=611 for defects having an area-equivalent diameter of at least 6 μm.

Another aspect is a tire tread comprising at least one elastomer and at least 15 phr silica, wherein the tread has a low voids concentration as indicated by the equation

$${A}_{V} \leq a \cdot {e}^{- bx} + c$$

wherein x=silica loading (phr) and Av is an area percentage of voids in a 1 μm thick tread slice and satisfies at least one of (i) and (ii):
(i) a=3.3, b=0.037, and c=0.1 for voids having an area-equivalent diameter of at least 2 μm; and
(ii) a=2.3, b=0.075, and c=0.28 for voids having an area-equivalent diameter of at least 3 μm.

Another aspect is a tire tread comprising at least one elastomer and at least 15 phr silica, wherein the tread has a low voids concentration as indicated by the equation

$${N}_{V} \leq a \cdot {e}^{- bx} + c$$

wherein x=silica loading (phr) and Ny is a number of voids per area in a 1 μm thick tread slice and satisfies at least one of (i) and (ii):
(i) a=800, b=0.02, and c=400 for voids having an area-equivalent diameter of at least 2 μm; and
(ii) a=480, b=0.1, and c=170 for voids having an area-equivalent diameter of at least 3 μm.

In any aspect disclosed herein, the total defect concentration satisfies at least one of (i) to (v) or satisfies at least one of (i) to (iv) or satisfies at least one of (i) to (iii), or satisfies (i) or (ii).

Another aspect is a tread comprising at least one elastomer and at least 15 phr of at least one silica, wherein a tire having the tread has one or more of the following: a rolling resistance coefficient of 7 N/kN RRc or less; a normalized rolling resistance coefficient of 95 or less; 10% decreased normalized rolling resistance compared to a tire tread of equivalent design having a comparable loading of carbon black filler; equivalent or decreased treadwear rate compared to a tire tread of equivalent design having a comparable loading of carbon black filler; 10% decreased normalized rolling resistance compared to a tire tread derived from a dry mix equivalent prepared from a dry filler and solid elastomer; equivalent or decreased treadwear rate compared to a tire tread derived from a dry mix equivalent prepared from a dry filler and solid elastomer.

With regard to any aspect or embodiment disclosed herein, where applicable, the tire tread can further comprise any one or more of the following embodiments: the silica is present in an amount of least 20 phr; the silica is precipitated silica; the silica is rice husk silica; the silica has a CTAB surface area ranging from 80 m²/g to 350 m²/g; the silica has a CTAB surface area ranging from 140 m²/g to 250 m²/g;

With regard to any aspect or embodiment disclosed herein, where applicable, the tire tread can further comprise any one or more of the following embodiments: the tire tread further comprises at least one additional filler selected from carbonaceous materials, carbon black, nanocellulose, lignin, clays, nanoclays, metal oxides, metal carbonates, pyrolysis carbon, reclaimed carbon, recovered carbon black, graphenes, graphene oxides, reduced graphene oxide, densified reduced graphene oxide granules, carbon nanotubes, single-wall carbon nanotubes, multi-wall carbon nanotubes, carbon nanostructures, fibrous fillers, hydrothermal carbon, nanocrystalline cellulose starch particles, polysaccharides, glucans, dextrans, microfibrillated cellulose, starch, siliceous earth, crumb rubber, and functionalized crumb rubber, or combinations thereof, and coated and treated materials; silica is present in an amount ranging from 25% to 99% by weight and the at least one additional filler is present in an amount ranging from 1% to 75% by weight relative to the total weight of filler.

With regard to any aspect or embodiment disclosed herein, where applicable, the tire tread can further comprise any one or more of the following embodiments: the at least one elastomer is selected from natural rubber, functionalized natural rubber, styrene-butadiene rubber, functionalized styrene-butadiene rubber, hydrogenated styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, thermoplastic block copolymers, and blends thereof; the at least one elastomer is selected from natural rubber, styrene-butadiene rubber, polybutadiene rubber, and blends thereof; the at least one elastomer comprises natural rubber in an amount of at least 20% by weight relative to the total weight of the elastomer; the at least one elastomer is natural rubber; the at least one elastomer is a blend comprising natural rubber and at least one of styrene-butadiene rubber, polybutadiene rubber.

With regard to any aspect or embodiment disclosed herein, where applicable, the tire tread can further comprise any one or more of the following embodiments: the tire tread is selected from truck-bus-radial (TBR) tire tread, off the road (OTR) tire tread, passenger car tire tread, performance vehicle tire tread, light truck tire tread, motorcycle tire tread, electric vehicle tire tread, and heavy equipment tire tread.

With regard to any aspect or embodiment disclosed herein, where applicable, the tire tread can further comprise any one or more of the following embodiments: the tire tread is derived from a composite formed from mixing the silica as a wet silica with the at least one elastomer as a solid elastomer.

### DETAILED DESCRIPTION

Disclosed herein are silica-containing tire treads (comprising silica filler dispersed in at least one elastomer) that provide good rolling resistance performance in a tire. Unexpectedly, these tire treads also offer wear performance that is at least comparable to equivalent treads having carbon black filler.

Tires and tire treads comprise rubber compounds selected for desired tire sizes, grades, and purposes. Treads are typically manufactured from elastomeric compounds reinforced with filler, such as carbon black and/or silica. While there are many known mixing techniques to optimize the dispersion of the filler in the elastomer, most commercially available mixing techniques have been unable to achieve excellent uniformity of dispersion of filler that may yield benefits in performance. As a result, a significant amount of undispersed filler remains present in the rubber compounds, acting as a source of defects in the rubber that can reduce one or more of rubber fatigue life, tear strength, and wear resistance.

While the quantification of carbon black dispersion (e.g., macrodispersion) has received much focus, there are numerous rubber compounds that contain a significant amount of particles other than carbon black. For example, many rubber products, including tire treads, incorporate silica as a filler. Zinc oxide (ZnO) is a common activator ingredient and is present in many rubber formulations. As with carbon black, a certain fraction of these other particle types remains undispersed. Transmission optical microscopic images of thin rubber slices containing carbon black, silica, and other particles can reveal a number of dark, gray, and bright spots. The dark spots, typically attributed to undispersed carbon black, provide good contrast with the background (gray) as carbon black has high light absorption properties. This contrast provides a handle for the measurement of carbon black dispersion through image analysis. However, silica and zinc oxide have poor light absorption properties, creating challenges in their measurement and analysis through optical microscopy. These particles have the potential to act as a source of defects, much like undispersed carbon black. As a result, for more complex rubber formulations that contain ingredients other than carbon black, a more complete picture on macrodispersion may not be observed with optical microscopy. It has been discovered that the undispersed silica and zinc oxide may be quantified using electron microscopy as described below.

Additionally, it was discovered surprisingly that a number of defect types, including undispersed carbon black, undispersed silica, zinc oxide, voids (cracks, tears, cavities, and the like) can be prevalent in reinforced elastomeric materials, including commercial tire treads. Undispersed carbon black, undispersed silica, zinc oxide, and voids are all imperfections in the rubber material; voids can be considered a defect type in addition to particulate defects (e.g., undispersed carbon black, silica, and zinc oxide). Because voids are essentially empty space free of solids and liquids, they can be identified and quantified as bright objects in the transmission optical microscopic images of thin rubber slices. In total, all of the defects described herein, namely undispersed carbon black, undispersed silica, zinc oxide, and voids, are defects that can lead to larger fissures, fractures, and cavities that can cause deterioration of the rubber compound. A combination of such defects in a tread can lead to poor performance, such as wear.

Disclosed herein are new tire treads comprising silica filler in which the tread has a low concentration of the defect types described herein. Such low concentrations of defects have not been observed in any known tire tread to date.

One aspect is a tire tread having a low total defect concentration. “Total defect concentration” as used herein refers to a measured quantity of defects in the tread arising from a combination of particles and voids. More specifically, total defect concentration can be the sum of particulate filler defects, such as undispersed filler (e.g., carbon black and/or silica), zinc oxide, and voids. Total defect concentration can be determined from a combination of optical microscopy and electron microscopy.

Without wishing to be bound by any theory, undispersed carbon black, undispersed silica, zinc oxide, and voids can have a noticeable impact on performance (e.g., tread performance); particulate defects can lead to cracks and cavities and voids can be regarded as pre-existing cracks and cavities in the compound, representing an advanced step towards rubber deterioration. Without wishing to be bound by any theory, the cracks and cavities from the particulate defects and voids are expected to grow in size from concentrated stresses under repeated extensive and compressive stresses with the tire rolling on the road, leading to crack growth to the surface of the tire, resulting in loss of rubber tread. Without wishing to be bound by any theory, the reduction of total defect concentration or voids alone can lead to improved rubber properties and performance. Accordingly, disclosed herein is a tire tread having a low concentration of total defects and/or voids, i.e., a low voids concentration.

As an option, the concentration of defects (total defect concentration and/or voids concentration) can be determined by analyzing microtomed sections of a tread. Microtomed sections can have a thickness of 2 μm or less, 1.5 μm or less, or 1 μm or less, e.g., 0.5 μm to 2 μm, 0.5 μm to 1.5 μm, e.g., about 1 μm. Any portion of the tread can be measured. As an option, total defect concentration is measured by sampling the center of the tread. The center of the tread can refer to the geometric center: center of radial direction of tire (i.e., at half of the tread depth) and center of lateral direction (middle of the lateral cross-section). For example, a sample can be taken from the middle of the lateral cross-section at half tread depth, e.g., half of +20%, +10%, or +5% the tread depth. Alternatively, the center of the tread can refer to the geometric center of the tread block, which is the center of a continuous block that does not contain a groove, e.g., a central portion of a rib or a lug at half tread depth. Typically, tire treads have a thickness ranging from 4 mm to 150 mm. Other thicknesses can range from 9 mm to 33 mm, e.g., for TBR tire tread, from 9 mm to 150 mm (e.g., from 60 mm to 150 mm) for OTR tire tread, and from 4 mm to 15 mm for passenger car tire tread. Without wishing to be bound by any theory, it is believed that voids are created, at least in part, by the formation of vapor from residual moisture during the curing process. Without wishing to be bound by any theory, it can be hypothesized that the center of the tread or tread block would typically contain the largest concentration of voids relative to the outer parts of the tread due, at least in part, to the longer paths required for vapor to diffuse out of the rubber. Reducing the concentration of voids, and thus total defect concentration, from the center of the tread can potentially result in reduction of the number of void defects from the remaining (e.g., outer) portions of the tread.

As an option, the concentration of defects can be determined by microscopy. For example, undispersed carbon black and voids can be determined by optical microscopy of microtomed sections of the tread. The optical microscopy can be performed in transmission mode, e.g., transmission light microscopy (TLM). Optical images (in transmission mode) of the microtomed sections typically show a light background populated by dark objects, each object the result of a collection of carbon black agglomerates. As the image is viewed in two-dimensional space, each dark object covers an area that can be likened to a type of “particle.” (For carbon black, the term “particle” is intended to represent an area coverage of carbon black agglomerates and is differentiated from “primary particles” that form a single carbon black aggregate.) This particle “diameter” is defined herein as an “area-equivalent circle diameter” of the filler and is typically in the micron size range. Accordingly, the dispersion state can be indicated by a form of particle size distributions, whether by area coverage of the particles, or number of particles per unit area having a certain size.

The concentration or amount of undispersed carbon black and voids can be determined with optical microscopy, such as transmission light microscopy. As an option, voids concentration can be determined as bright objects by optical microscopy in transmission mode of microtomed sections of the tread. As an option, the amount of undispersed silica, zinc oxide, and voids may also be measured with a scanning electron microscope (SEM) by using a back scattering electron detector with the microtomed sections of the tread positioned on an indium tin oxide (ITO) coated slide. Use of an ITO substrate can change or enhance the contrast of undispersed silica, zinc oxide, and voids against the background in the SEM images. As another option, the tread can be cut into microtomed sections after cooling the tread to a temperature around or below the rubber glass transition temperature, e.g., about −20° C. or lower, e.g., about −30° C. or lower, about-50° C. or lower, about −100° C. or lower, e.g., from −20° C. to −130° C. or from −50° C. to −130° C. or from −100° C. to −130° C. The cooled microtome sections can then be placed on the ITO-coated slide and allowed to warm to room temperature prior to measuring by an optical microscope or SEM.

While undispersed silica and/or zinc oxide cannot be detected reliably by optical microscopy due to lack of contrast, as an option, they can be detected by scanning electron microscopy (SEM). As another option, the SEM measurement can be performed with a back-scattering electron (BSE) detector, i.e., SEM/BSE, which creates high contrast between metal oxides and carbon black or rubber, due to much higher electron backscattering efficiency of much higher atomic number of silicon and zinc atoms than the carbon atoms. This setup enables silica and zinc oxide to be detected as light grey objects against darker rubber and carbon black background. The electron beam accelerating voltage can be adjusted so that the beam would have longer penetration depth in rubber than the thickness of the rubber slice for detecting all undispersed silica and zinc oxide in the thin rubber slice from their back scattered electrons. This is much like the transmission optical microscopy for detecting all undispersed carbon black in the rubber slice instead of detecting just undispersed silica and zinc oxide on the rubber surface with a conventional secondary electron detector. As an option, the contrast can be further improved by placing the rubber on an indium tin oxide (ITO) coated slide as the back scattering from the ITO coating under the rubber slice can increase the overall back scattering electron intensity that enables detection of voids as very bright objects in the SEM/BSE images.

In one aspect, the tread can be characterized by a total concentration of defects arising from (at least) the following sources: undispersed filler (e.g., carbon black and/or silica), zinc oxide particles, and voids. As an option, the tread can be characterized by a total concentration of defects arising from undispersed carbon black, undispersed silica, zinc oxide, and voids. In another aspect, the tread can be characterized by a concentration of void defects alone.

One aspect is a tire tread comprising at least one elastomer and at least 15 phr of silica (the silica is dispersed in the at least one elastomer), wherein the tread has a low total defect concentration indicated by a value A_{T}, defined as an area percentage of defects of a 1-μm thick rubber slice, satisfying at least one of (i) to (vi):
(i) A_{T}≤2.7% for defects having an area-equivalent diameter of at least 2 μm;
(ii) A_{T}≤1.4% for defects having an area-equivalent diameter of at least 3 μm;
(iii) A_{T}≤0.75% for defects having an area-equivalent diameter of at least 4 μm;
(iv) A_{T}≤0.5% for defects having an area-equivalent diameter of at least 5 μm;
(v) A_{T}≤0.33% for defects having an area-equivalent diameter of at least 6 μm; and
(vi) A_{T}≤0.15% for defects having an area-equivalent diameter of at least 10 μm.

As options for A_{T}:
(i) A_{T}≤2.5% for defects having an area-equivalent diameter of at least 2 μm or A_{T}≤2% for defects having an area-equivalent diameter of at least 2 μm, or A_{T}≤1.5% for defects having an area-equivalent diameter of at least 2 μm, or A_{T}≤1% for defects having an area-equivalent diameter of at least 2 μm, or A_{T}≤0.9% for defects having an area-equivalent diameter of at least 2 μm; or
(ii) A_{T}≤1% for defects having an area-equivalent diameter of at least 3 μm, or A_{T}≤0.9% for defects having an area-equivalent diameter of at least 3 μm; or A_{T}≤0.8% for defects having an area-equivalent diameter of at least 3 μm; or A_{T}≤0.7% for defects having an area-equivalent diameter of at least 3 μm; or
(iii) A_{T}≤0.6% for defects having an area-equivalent diameter of at least 4 μm; or
(iv) A_{T}≤0.4% for defects having an area-equivalent diameter of at least 5 μm; or
(v) A_{T}≤0.3% for defects having an area-equivalent diameter of at least 6 μm; or
(vi) A_{T}≤0.1% for defects having an area-equivalent diameter of at least 10 μm.

Another aspect is a tire tread comprising at least one elastomer and at least 15 phr of silica wherein the tread has a low total defect concentration indicated by a value N_{T}, defined as number of defects per area of a 1-μm thick rubber slice, satisfying at least one of (i) to (vi):
(i) N_{T}≤1700/mm² for defects having an area-equivalent diameter of at least 2 μm;
(ii) N_{T}≤950/mm² for defects having an area-equivalent diameter of at least 3 μm;
(iii) N_{T}≤250/mm² for defects having an area-equivalent diameter of at least 4 μm;
(iv) N_{T}≤100/mm² for defects having an area-equivalent diameter of at least 5 μm; and

(v) N_{T}≤50/mm² for defects having an area-equivalent diameter of at least 6 μm.

As an alternative, N_{T} can be defined generically (for any thickness rubber slice) as a number of defects per volume (number/mm²-μm).

As options for N_{T}:
(i) N_{T}≤1600/mm² for defects having an area-equivalent diameter of at least 2 μm, or N_{T}≤1500/mm² for defects having an area-equivalent diameter of at least 2 μm, or N_{T}≤1200/mm² for defects having an area-equivalent diameter of at least 2 μm, or N_{T}≤1000/mm² for defects having an area-equivalent diameter of at least 2 μm, or N_{T}≤900/mm² for defects having an area-equivalent diameter of at least 2 μm, or N_{T}≤800/mm² for defects having an area-equivalent diameter of at least 2 μm;
(ii) N_{T}≤900/mm² for defects having an area-equivalent diameter of at least 3 μm, or N_{T}≤800/mm² for defects having an area-equivalent diameter of at least 3 μm, or N_{T}≤700/mm² for defects having an area-equivalent diameter of at least 3 μm, or N_{T}≤600/mm² for defects having an area-equivalent diameter of at least 3 μm, or N_{T}≤500/mm² for defects having an area-equivalent diameter of at least 3 μm, or N_{T}≤400/mm² for defects having an area-equivalent diameter of at least 3 μm, or N_{T}≤300/mm² for defects having an area-equivalent diameter of at least 3 μm;
(iii) N_{T}≤200/mm² for defects having an area-equivalent diameter of at least 4 μm, or N_{T}≤150/mm² for defects having an area-equivalent diameter of at least 4 μm;
(iv) N_{T}≤100/mm² for defects having an area-equivalent diameter of at least 5 μm, or N_{T}≤90/mm² for defects having an area-equivalent diameter of at least 5 μm, or N_{T}≤80/mm² for defects having an area-equivalent diameter of at least 5 μm.

Another aspect is a tread comprising at least one elastomer and at least 15 phr of at least one silica, wherein the tread has a low voids concentration indicated by a value A_{V}, defined as an area percentage of voids of a 1-μm thick rubber slice, satisfying at least one of (i) and (ii):
(i) A_{V}≤0.6% for voids having an area-equivalent diameter of at least 2 μm; and
(ii) A_{V}≤0.4% for voids having an area-equivalent diameter of at least 3 μm.

As options for A_{V}:
(i) A_{V}≤0.5% for voids having an area-equivalent diameter of at least 2 μm, or A_{V}≤0.4% for voids having an area-equivalent diameter of at least 2 μm;
(ii) A_{V}≤0.3% for voids having an area-equivalent diameter of at least 3 μm.

Another aspect is a tread comprising at least one elastomer and at least 15 phr of at least one silica, wherein the tread has a low voids concentration indicated by a value N_{V}, defined as number of voids per area of a 1-μm thick rubber slice, satisfying at least one of (i) to (vi):
(i) N_{V}≤500/mm² for voids having an area-equivalent diameter of at least 2 μm;
(ii) N_{V}≤150/mm² for voids having an area-equivalent diameter of at least 3 μm; and
(iii) NV ≤65/mm² for voids having an area-equivalent diameter of at least 4 μm.

As options for N_{V}:
(i) N_{V}≤400/mm² for voids having an area-equivalent diameter of at least 2 μm;
(ii) NV ≤140/mm² for voids having an area-equivalent diameter of at least 3 μm, or N_{V}≤130/mm² for voids having an area-equivalent diameter of at least 3 μm;
(iii) N_{V}≤60/mm² for voids having an area-equivalent diameter of at least 4 μm.

As an alternative, NV can be defined generically (for any thickness rubber slice) as a number of voids per volume (number/mm²-μm).

Another aspect is a tread comprising at least one elastomer and at least 15 phr of at least one silica, wherein the tread has a low total defect or voids concentration defined as a function of silica loading (phr). The total defects or voids concentration per area in a 1 μm thick tread slice can be represented by the equation below:

$$a \cdot {e}^{- bx} + c$$

where x=silica loading (phr), and a, b, and c are variables depending on defect type and size.

One aspect is a tire tread comprising at least one elastomer and at least 15 phr silica, wherein the tread has a low total defect concentration as indicated by the equation

$${A}_{T} \leq a \cdot {e}^{- bx} + c$$

wherein x=silica loading (phr) and A_{T} is an area percentage of defects in a 1 μm thick tread slice and satisfies at least one of (i) to (v):
(i) a=4, b=0.08, and c=1.9 for defects having an area-equivalent diameter of at least 2 μm;
(ii) a=2.4, b=0.07, and c=1 for defects having an area-equivalent diameter of at least 3 μm;
(iii) a=0.8, b=0.008, and c=0.09 for defects having an area-equivalent diameter of at least 4 μm;
(iv) a=−0.73, b=0.15, and c=0.93 for defects having an area-equivalent diameter of at least 5 μm; and
(v) a=−5.26, b=0.001, and c=5.38 for defects having an area-equivalent diameter of at least 6 μm.

As an option, at least one of the following applies for A_{T}:
(i) a=3.5, b=0.8, and c=1.5 for defects having an area-equivalent diameter of at least 2 μm;
(ii) a=2.1, b=0.07, and c=0.79 for defects having an area-equivalent diameter of at least 3 μm;
(iii) a=0.7, b=0.008, and c=0.08 for defects having an area-equivalent diameter of at least 4 μm;
(iv) a=0.5, b=0.002, and c=0 for defects having an area-equivalent diameter of at least 5 μm; and
(v) a=−5.3, b=0.001, and c=5.35 for defects having an area-equivalent diameter of at least 6 μm.

Another aspect is a tread comprising at least one elastomer and at least 15 phr of at least one silica, wherein the tread has a low total defect concentration as indicated by the equation

$${N}_{T} \leq a \cdot {e}^{- bx} + c$$

wherein x=silica loading (phr) and N_{T} is a number of defects per area in a 1 μm thick tread slice and satisfies at least one of (i) to (v):
(i) a=2500, b=0.007, and c=0 for defects having an area-equivalent diameter of at least 2 μm;
(ii) a=1500, b=0.018, and c=0 for defects having an area-equivalent diameter of at least 3 μm;
(iii) a=580, b=0.14, and c=240 for defects having an area-equivalent diameter of at least 4 μm;
(iv) a=−30, b=0.01, and c=120 for defects having an area-equivalent diameter of at least 5 μm; and
(v) a=−590, b=0.0014, and c=611 for defects having an area-equivalent diameter of at least 6 μm.

As an option, at least one of the following applies for N_{T}:
(i) a=2100, b=0.009, and c=0 for defects having an area-equivalent diameter of at least 2 μm;
(ii) a=1400, b=0.022, and c=0 for defects having an area-equivalent diameter of at least 3 μm;
(iii) a=450, b=0.14, and c=180 for defects having an area-equivalent diameter of at least 4 μm;
(iv) a=−30, b=0.01, and c=105 for defects having an area-equivalent diameter of at least 5 μm; and
(v) a=−590, b=0.0013, and c=600 for defects having an area-equivalent diameter of at least 6 μm.

Another aspect is a tire tread comprising at least one elastomer and at least 15 phr silica, wherein the tread has a low voids concentration as indicated by the equation

$${A}_{V} \leq a \cdot {e}^{- bx} + c$$

wherein x=silica loading (phr) and Av is an area percentage of voids in a 1 μm thick tread slice and satisfies at least one of (i) and (ii):
(i) a=3.3, b=0.037, and c=0.1 for voids having an area-equivalent diameter of at least 2 μm; and
(ii) a=2.3, b=0.075, and c=0.28 for voids having an area-equivalent diameter of at least 3 μm.

As an option, at least one of the following applies for A_{V}:
(i) a=2.5, b=0.037, and c=0.1 for voids having an area-equivalent diameter of at least 2 μm; and
(ii) a=1.9, b=0.075, and c=0.25 for voids having an area-equivalent diameter of at least 3 μm.

Another option is a tire tread comprising at least one elastomer and at least 15 phr silica, wherein the tread has a low voids concentration as indicated by the equation

$${N}_{V} \leq a \cdot {e}^{- bx} + c$$

wherein x=silica loading (phr) and Ny is a number of voids per area in a 1 μm thick tread slice and satisfies at least one of (i) and (ii):
(i) a=800, b=0.02, and c=400 for voids having an area-equivalent diameter of at least 2 μm; and
(ii) a=480, b=0.1, and c=170 for voids having an area-equivalent diameter of at least 3 μm.

As an option, at least one of the following applies for A_{V}:
(i) a=720, b=0.05, and c=370 for voids having an area-equivalent diameter of at least 2 μm; and
(ii) a=430, b=0.12, and c=140 for voids having an area-equivalent diameter of at least 3 μm.

As an option, the total defect or voids concentration in the tire tread, whether indicated by A_{T}, N_{T}, A_{V}, or N_{V}, can satisfy, where applicable, at least one of (i) to (v), or at least one of (i) to (iv), or at least one of (i) to (iii), or the tire tread can satisfy (i) or (ii). As an option the total defect and/or voids concentration can satisfy two or three or four or five or all of (i) to (vi). For example, total defects and/or voids concentration can satisfy, where applicable, all of (i) to (v), or all of (i) to (iv), or all of (i) to (iii), or (i) and (ii). As another option, the total defects and/or voids concentration can satisfy, where applicable, all of (ii) to (v), or all of (ii) to (iv), or (ii) and (iii).

For a 1-μm thick slice, Ar and Av can have minimum values of 0.1% or 0.05% or 0.01% or 0.005% or 0.001% or 0.0005% or 0.0001%. For example, Ar can range from 0.0001% to 2.7% for defects having an area-equivalent diameter of at least 2 μm or Av can range from 0.0001% to 0.6% for voids having an area-equivalent diameter of at least 2 μm (or any range in between). N_{T} and Ny can have minimum values of 1/mm² or 0.5/mm² or 0.1/mm² or 0.09/mm². For example, N_{T} can range from 0.09/mm² to 1700/mm² for defects having an area-equivalent diameter of at least 2 μm or Ny can range from 0.09/mm² to 500/mm² for voids having an area-equivalent diameter of at least 2 μm (or any range in between). As other options for a 1-μm thick slide: Ar can have minimum values of 0.1% or 0.05% (e.g., for defects having an area-equivalent diameter of at least 2 μm or at least 3 μm or at least 4 μm or at least 5 μm or at least 6 μm or at least 10 μm); or N_{T} can have minimum values, where applicable, of 100/mm² (e.g., for defects having an area-equivalent diameter of at least 2 μm or at least 3 μm or at least 4 μm) or 10/mm² or 1/mm² (e.g., for defects having an area-equivalent diameter of at least 2 μm or at least 3 μm or at least 4 μm or at least 5 μm or at least 6 μm); Av can have minimum values of 0.01% or 0.005% or 0.001% or 0.0005% or 0.0001% (e.g., for defects having an area-equivalent diameter of at least 2 μm or at least 3 μm); Ny can have minimum values, where applicable, of 100/mm² (e.g., for voids having an area-equivalent diameter of at least 2 μm or at least 3 μm) or 10/mm² or 1/mm² or 0.5/mm² or 0.1/mm² or 0.09/mm² (e.g., for voids having an area-equivalent diameter of at least 2 μm or at least 3 μm or at least 4 μm).

As another option, the defect concentration can satisfy two or more combinations of A_{T}, N_{T}, A_{V}, and Ny. For example, the defect concentration can satisfy A_{T} and N_{T} (i.e., the tire tread has a low total defect concentration as defined by area percent or number density), or Av and Ny (i.e., the tire tread has a low voids concentration as defined by area percent or number density), or A_{T}, N_{T}, and A_{V}, or A_{T}, N_{T}, and N_{V}, or the tire tread can have both low total defect concentration and low voids concentration as defined by area percent or number density.

The tire treads disclosed herein contain a significant amount of silica as the reinforcing filler. As an option, silica is present in the tread in an amount of at least 15 phr, e.g., at least 20 phr, at least 25 phr, at least 30 phr, at least 35 phr, or at least 40 phr. As an option, the amount of silica present in the tread can range from 15 phr to 250 phr, from 15 phr to 200 phr, from 15 phr to 150 phr, from 15 phr to 120 phr, from 15 phr to 100 phr, from 15 phr to 80 phr, from 15 phr to 70 phr, from 15 phr to 60 phr, from 15 phr to 50 phr, from 20 phr to 250 phr, from 20 phr to 200 phr, from 20 phr to 150 phr, from 20 phr to 120 phr, from 20 phr to 100 phr, from 20 phr to 80 phr, from 20 phr to 70 phr, from 20 phr to 60 phr, from 20 phr to 50 phr, from 30 phr to 250 phr, from 30 phr to 200 phr, from 30 phr to 150 phr, from 30 phr to 100 phr, from 30 phr to 80 phr, from 30 phr to 70 phr, from 30 phr to 60 phr, from 30 phr to 50 phr, from 25 phr to 150 phr, from 25 phr to 100 phr, from 25 phr to 80 phr, from 25 phr to 70 phr, from 25 phr to 60 phr, from 25 phr to 50 phr, from 35 phr to 150 phr, from 35 phr to 100 phr, from 35 phr to 80 phr, from 35 phr to 70 phr, from 40 phr to 150 phr, from 40 phr to 100 phr, from 40 phr to 90 phr, from 40 phr to 80 phr, from 40 phr to 70 phr, from 40 to 60 phr, and the like.

As an option, the tire tread further comprises at least one additional filler, resulting in a filler blend dispersed in the at least one elastomer. For example, the at least one additional filler can be selected from carbonaceous materials, carbon black, nanocellulose, lignin, clays, nanoclays, metal oxides, metal carbonates, pyrolysis carbon, reclaimed carbon, recovered carbon black, graphenes, graphene oxides, reduced graphene oxide, densified reduced graphene oxide granules, carbon nanotubes, single-wall carbon nanotubes, multi-wall carbon nanotubes, carbon nanostructures, fibrous fillers, hydrothermal carbon, nanocrystalline cellulose starch particles, polysaccharides, glucans, dextrans, microfibrillated cellulose, starch, siliceous earth, crumb rubber, and functionalized crumb rubber, or combinations thereof, and coated and treated materials thereof (e.g., silicon-treated carbon black, such as Ecoblack™ silicon-treated carbon blacks are available from Cabot Corporation or as described in U.S. Pat. No. 6,028,137, the disclosure of which is incorporated herein by reference). Fibrous fillers can have an aspect ratio of, e.g., 2:1 or more, 3:1 or more, 4:1 or more, or higher e.g., 5:1 or 10:1, 100:1, 200:1, or up to 106:1. Typically, fillers used for reinforcing elastomers have dimensions that are microscopic (e.g., hundreds of microns or less) or nanoscale (e.g., less than 1 micron). If present in the composite, the fibrous filler can be present in an amount ranging from 1 wt. % to 10 wt. % relative to the total amount of filler containing at least 15 phr silica. The at least one additional filler can be incorporated into a composite as a wet or dry filler or a combination of wet and dry filler.

The amount of at least one additional filler can vary so long as the amount of silica in the elastomer is at least 15 phr or other amounts disclosed herein. For example, silica can be present in an amount ranging from 25% to 99% by weight relative to the total weight of the filler and the at least one additional filler (which can comprise one or more filler types different from silica) will make up the remainder of the filler content. For example, the amount of silica relative to the total weight of the filler blend ranges from 25% to 95%, from 25% to 85%, from 25% to 80%, from 25% to 75%, from 25% to 70%, from 25% to 65%, from 25% to 60%, from 25% to 55%, from 25% to 50%, from 25% to 45%, from 25% to 40%, or from 25% to 35%, with at least one additional filler makes up the remainder (e.g., from 1% to 75% by weight relative to the total weight of the filler blend or other ranges in between depending on the selected range of silica amounts).

As an example, the at least one additional filler can be carbon black and the tread can comprise a filler blend of silica and carbon black, where the amount of silica ranges from 25% to 99% by weight and the amount of carbon black ranges from 1% to 75% by weight (e.g., from 1% to 60% by weight or from 1% to 50% by weight) or the amount of silica ranges from 25% to 95% by weight and the amount of carbon black ranges from 5% to 75% by weight (e.g., from 5% to 60% by weight or from 5% to 50% by weight). Silica can represent the majority or minority of the filler so long as silica is present in an amount of at least 15 phr. Where silica is the majority filler in a filler blend with at least one additional filler, such as carbon black, silica can be present in an amount up to 200 phr or 150 phr or 100 phr, e.g., when resins or oil is present (e.g. resins and/or oils can be present in an amount ranging from 10 phr to 100 phr). For example, silica can be present in an amount ranging from 30 phr to 150 phr or from 35 phr to 100 phr, e.g., ranging from 35 phr to 90 phr, from 35 phr to 80 phr, or from 35 phr to 70 phr, and carbon black can be present in an amount ranging from 1 phr to 30 phr, from 2 phr to 30 phr, 3 phr to 30 phr, from 5 phr to 30 phr, e.g., from 5 phr to 20 phr, or from 5 phr to 10 phr. Where silica is the minority filler, silica can be present in an amount ranging from 15 phr to 30 phr (or from 15 phr to 25 phr) and carbon black can be present in an amount ranging from 20 phr to 50 phr, from 20 phr to 45 phr, from 20 phr to 40 phr, e.g., from 20 phr to 35 phr, from 25 phr to 50 phr, from 25 phr to 40 phr, or from 25 phr to 35 phr.

One or more types of silica, or any combination of silica(s), can be used in any embodiment disclosed herein. The silica can include or be precipitated silica, fumed silica, silica gel, and/or colloidal silica. The silica can be or include untreated silica and/or chemically-treated silica. The silica can be rice husk silica or silica derived from rice husk ash or other biogenic sources. The silica can be suitable for reinforcing elastomer composites and can be characterized by a CTAB surface area ranging from 80 m²/g to 350 m²/g, e.g., from 80 m²/g to 250 m²/g, from 100 m²/g to 350 m²/g, from 100 m²/g to 250 m²/g, from 120 m²/g to 350 m²/g, from 120 m²/g to 250 m²/g, from 140 m²/g to 350 m²/g, or from 140 m²/g to 250 m²/g.

Alternatively, silica can be characterized by a Brunaur Emmett Teller surface area (BET, as determined by multipoint BET nitrogen adsorption, ASTM D1993) ranging from 20 m²/g to 700 m²/g; or ranging from 20 m²/g to 500 m²/g; or ranging from 20 m²/g to 450 m²/g; or ranging from 20 m²/g to 200 m²/g; or ranging from 20 m²/g to 150 m²/g; or ranging from 30 m²/g to 450 m²/g; or ranging from 30 m²/g to 400 m²/g; or ranging from 60 m²/g to 250 m²/g; or ranging from 60 m²/g to 250 m²/g; or ranging from 80 m²/g to 700 m²/g; or ranging from 80 m²/g to 500 m²/g; or ranging from 80 m²/g to 300 m²/g; or ranging from 80 m²/g to 200 m²/g.

Highly dispersible precipitated silica can be used as the filler in the present methods. Highly dispersible precipitated silica (“HDS”) is understood to mean any silica having a substantial ability to dis-agglomerate and disperse in an elastomeric matrix. Such dispersion determinations may be observed in known manner by electron or optical microscopy on thin sections of elastomer composite. Examples of commercial grades of HDS include, Perkasil® GT 3000GRAN silica from WR Grace & Co, Ultrasil® 7000 silica from Evonik Industries, Zeosil® 1165 MP, 1115 MP, Premium, and 1200 MP silica from Solvay S. A., Hi-Sil® EZ 160G silica from PPG Industries, Inc., and Zeopol® 8741 or 8745 silica from Evonik Industries. Conventional non-HDS precipitated silica may be used as well. Examples of commercial grades of conventional precipitated silica include, Perkasil® KS 408 silica from WR Grace & Co, Zeosil® 175GR silica from Solvay S. A., Ultrasil® VN3 silica from Evonik Industries, and Hi-Sil® 243 silica from PPG Industries, Inc. Precipitated silica with surface attached silane coupling agents may also be used. Examples of commercial grades of chemically-treated precipitated silica include Agilon®400, 454, or 458 silica from PPG Industries, Inc. and Coupsil silicas from Evonik Industries, for example Coupsil® 6109 silica. Other examples of chemically-treated silicas include those sold as Efficium® Highly Dispersible Silica from Solvay S. A., and those disclosed in U.S. Pat. Publ. No. 2017/0058111, the disclosure of which is incorporated by reference herein.

As an additional filler, the carbon black used in any of the methods disclosed herein can be any grade of reinforcing carbon blacks and semi-reinforcing carbon blacks. Examples of ASTM grade reinforcing grades are N110, N121, N134, N220, N231, N234, N299, N326, N330, N339, N347, N351, N358, and N375 carbon blacks. Examples of ASTM grade semi-reinforcing grades are N539, N550, N650, N660, N683, N762, N765, N774, N787, N990 carbon blacks and/or N990 grade thermal blacks.

The carbon black can have a statistical thickness surface area (STSA) ranging from 30 m²/g to 200 m²/g, e.g., from 60 m²/g to 200 m²/g or from 60 m²/g to 170 m²/g. The carbon black can have a compressed oil absorption number (COAN) ranging from 30 mL/100g to 150 mL/100g, e.g., from 60 mL/100g to 120 mL/100g. STSA (statistical thickness surface area) is determined based on ASTM Test Procedure D-5816 (measured by nitrogen adsorption). Compressed oil absorption number (COAN) is determined according to ASTM D3493. As an option, the carbon black can have a STSA ranging from 60 m²/g to 150 m²/g with a COAN of from 70 mL/100g to 115 mL/100g.

As stated, the carbon black can be a rubber black, and especially a reinforcing grade of carbon black or a semi-reinforcing grade of carbon black. Carbon blacks sold under the Regal®, Black Pearls®, Spheron®, Sterling®, Propel®, Endure®, and Vulcan® trademarks available from Cabot Corporation, the Raven®, Statex®, Furnex®, and Neotex® trademarks and the CD and HV lines available from Birla Carbon (formerly available from Columbian Chemicals), and the Corax®, Durax®, Ecorax®, and Purex® trademarks and the CK line available from Orion Engineered Carbons (formerly Evonik and Degussa Industries), and other fillers suitable for use in rubber or tire applications, may also be exploited for use with various implementations. Suitable chemically functionalized carbon blacks include those disclosed in WO 96/18688 and US2013/0165560, the disclosures of which are hereby incorporated by reference. Mixtures of any of these carbon blacks may be employed. Carbon blacks having surface areas and structures beyond the ASTM grades and typical values selected for mixing with rubber, such as those described in U.S. Patent Application Publ. No. 2018/0282523, the disclosure of which is incorporated herein by reference, may be used in the wet filler and in the composite made by any of the methods disclosed herein.

The tread can include one or more elastomer types, including natural rubber (NR), synthetic elastomers such as styrene butadiene rubbers (SBR, e.g., solution SBR (SSBR), emulsion SBR (ESBR), or oil-extended SSBR (OESSBR)), polybutadiene (BR), polyisoprene rubbers (IR), functionalized SBR, functionalized BR, functionalized NR, ethylene-propylene rubber (e.g., EPDM), isobutylene-based elastomers (e.g., butyl rubber), halogenated butyl rubber, polychloroprene rubber (CR), nitrile rubbers (NBR), hydrogenated nitrile rubbers (HNBR), fluoroelastomers, perfluoroelastomers, and silicone rubber, e.g., natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, nitrile rubber, hydrogenated nitrile rubber, and blends thereof, or e.g., natural rubber, styrene-butadiene rubber, polybutadiene rubber, and blends thereof, e.g., a blend of first and second elastomers. Other synthetic polymers that can be used in the present methods (whether alone or as blends) include hydrogenated SBR, and thermoplastic block copolymers (e.g., such as those that are recyclable). Synthetic polymers include copolymers of ethylene, propylene, styrene, butadiene and isoprene. Other synthetic elastomers include those synthesized with metallocene chemistry in which the metal is selected from Ce, Pr, Nd, Sm, Gd, Tb, Dy, Ho, Tm, Yb, Lu, Co, Ni, and Ti. Polymers made from bio-based monomers can also be used, such as monomers containing modern carbon as defined by ASTM D6866, e.g., polymers made from bio-based styrene monomers disclosed in U.S. Pat. No. 9,868,853, the disclosure of which is incorporated by reference herein, or polymers made from bio-based monomers such as butadiene, isoprene, ethylene, propylene, farnesene, and comonomers thereof.

If two or more elastomers are used, the two or more elastomers can be charged into the mixer as a blend at the same time (as one charge or two or more charges) or the elastomers can be added separately in any sequence and amount. For example, the at least one elastomer can comprise natural rubber. As another option, the at least one elastomer can comprise natural rubber blended with one or more of the elastomers disclosed herein, e.g., butadiene rubber and/or styrene-butadiene rubber, etc.

The tread can comprise an elastomer that can be or include natural rubber. If the elastomer is a blend, it can include at least 20 wt. %, at least 30 wt. %, at least 40 wt. %, at least 50 wt. %, at least 70 wt. %, at least 80% wt. %, at least 90 wt. %, or at least 95 wt. % natural rubber. The blend can further comprise synthetic elastomers such as one or more of styrene-butadiene rubber, functionalized styrene-butadiene rubber, and polybutadiene rubber, and/or any other elastomers disclosed herein. The final tread can comprise natural rubber in an amount of at least 20% by weight relative to the total weight of the elastomer, e.g., at least 30% by weight, at least 40% by weight, at least 50% by weight, at least 70% by weight, at least 80% by weight, at least 90% by weight, at least 95% by weight, or the final tread comprises an elastomer that is substantially all natural rubber (e.g., up to 99% or up to 100% by weight relative to the total weight of the elastomer). As an option, the elastomer in the tread is a blend comprising natural rubber in an amount ranging from 20% to 99% by weight, from 20% to 95% by weight, from 20% to 90% by weight relative to the total weight of the elastomer, e.g., from 20% by weight to 80% by weight, from 20% to 70% by weight, from 20% to 60% by weight, from 20% to 50% by weight, from 30% to 99% by weight, from 30% to 95% by weight, from 30% to 90% by weight, from 30% by weight to 80% by weight, from 30% to 70% by weight, from 30% to 60% by weight, from 30% to 50% by weight, from 40% to 99% by weight, from 40% to 95% by weight, from 40% to 90% by weight, from 40% by weight to 80% by weight, from 40% to 70% by weight, from 40% to 60% by weight, from 40% to 50% by weight, from 50% to 99% by weight, from 50% to 95% by weight, from 50% to 90% by weight, from 50% by weight to 80% by weight, from 50% to 70% by weight, from 60% to 99% by weight, from 60% to 95% by weight, from 60% to 90% by weight, from 60% by weight to 80% by weight, from 60% to 70% by weight, with the remainder being a different elastomer such as at least one of styrene-butadiene rubber, functionalized styrene-butadiene rubber, and polybutadiene rubber, and/or any other elastomers disclosed herein. For example, the tread can be a blend comprising natural rubber, styrene-butadiene rubber, and polybutadiene rubber in respective amounts of 50-80 wt. % natural rubber, 10 to 40 wt. % styrene-butadiene rubber, and 5 to 30 wt. % polybutadiene rubber.

In other embodiments, the elastomer can contain natural rubber in small amounts e.g., from 0.1% to 10% by weight relative to the total weight of the at least one elastomer, or no natural rubber (0 wt. %). In certain embodiments, the at least one elastomer can comprise at least 50%, e.g., at least 60%, at least 70%, at least 80%, at least 90%, at least 95%, at least 99% and up to 99% or 95% or 90% by weight of polybutadiene rubber, with the remainder comprising any elastomer(s) disclosed herein, e.g., at least one of natural rubber and styrene-butadiene rubber. In certain embodiments, the elastomer can be 100% polybutadiene rubber. In certain embodiments, the elastomer can comprise at least 50% styrene-butadiene rubber, e.g., at least 60%, at least 70%, at least 80%, at least 90%, at least 95%, at least 99% and up to 99% or 95% or 90% by weight of styrene-butadiene rubber, with the remainder comprising any elastomer(s) disclosed herein, e.g., at least one of natural rubber and polybutadiene rubber. In certain embodiments, the elastomer can be 100% styrene-butadiene rubber. In yet other embodiments, the elastomer can comprise a blend of styrene-butadiene rubber and butadiene rubber, e.g., in ratios ranging from 5:1 to 1:1, from 4:1 to 1:1, from 3:1 to 1:1, from 1:1 to 3:1, from 1:1 to 4:1 or from 1:1 to 5:1.

The natural rubber may also be chemically modified in some manner. For example, it may be treated to chemically or enzymatically modify or reduce various non-rubber components, or the rubber molecules themselves may be modified with various monomers or other chemical groups such as chlorine. Other examples include epoxidized natural rubber and natural rubber having a nitrogen content of at most 0.3 wt. %, as described in PCT Publ. No. WO 2017/207912.

Other exemplary elastomers include, but are not limited to, rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, propylene and the like.

Other applicable solid elastomers that can be used in the presently disclosed methods are disclosed in PCT Publ. No. WO 2020/247663, the disclosure of which is incorporated by reference herein.

It is known that silica-containing tire treads (tire treads comprising silica dispersed in at least one elastomer) can provide a tire with good rolling resistance properties. However, such treads display poorer wear performance compared to carbon black-reinforced treads and thus far, good wear performance was not achievable for these treads, e.g., treads comprising natural rubber. However, the present silica-containing treads can provide equivalent, and in some instances, better wear performance than previously attained for carbon black-containing treads.

Wear performance of the present tire treads can be measured against an equivalent tread as a control, i.e., treads of equivalent tread pattern having a comparable loading of carbon black as the reinforcing filler (equivalent tread control). Without wishing to be bound by any theory, it can be hypothesized that good wear performance was achieved, at least in part, with a tread having a lower total defects concentration and/or voids concentration, which can lead to the reduction of the cracks and cavities and the like that can cause rubber deterioration. The present treads, having at least 15 phr silica, can provide equivalent or decreased treadwear rate compared to an equivalent tread (e.g., reinforced by a comparable loading of carbon black filler). As an option, a comparable loading of carbon black replaces the silica with an equivalent volume fraction of carbon black. For example, if the present tire tread has 55 phr silica, the control tread has an equivalent tread design with a volume fraction equivalent amount of carbon black (e.g., about 50 phr carbon black). As another option, a comparable loading of carbon black replaces the silica with an amount of carbon black to achieve comparable stiffness/hardness properties. For example a comparable loading of carbon black gives a comparable Shore A hardness.

As an option, an indication of treadwear can be treadwear rate, which is a measure of the tread depth loss per distance travelled (mm/km). As another option, treadwear rate can be a measure of normalized tread depth loss per distance travelled (%). For example, the equivalent tire tread control can be assigned a normalized tread depth loss per distance travelled equal to 100%. The present tire tread, containing at least 15 phr silica, can match the tread depth loss as indicated by a normalized tread depth loss per distance travelled of 100%, or the present tread can show improved performance (decreased tread wear rate) as indicated by a normalized tread depth loss per distance travelled less than 100%, e.g., less than 95%.

As the present treads have a significant amount of silica as filler, a tire having a silica-containing tread can also have good rolling resistance properties compared to the equivalent tread control containing carbon black as filler. Rolling resistance properties can be defined by rolling resistance coefficient ranges, which can be determined by the test protocol, ECE Regulation Number 117 Annex 6. As an option, tires having the present treads have a rolling resistance coefficient of 7 N/KN RRc or less, e.g., a rolling resistance coefficient of 6.5 N/kN RRc or less, or 6 N/kN RRc or less.

As another option, a tire having the present silica-containing tread can have improved rolling resistance properties as indicated by normalized rolling resistance coefficient. The normalized rolling resistance coefficient can be measured against a tire having a control tire tread of equivalent design and a comparable loading of carbon black filler. If the normalized rolling resistance coefficient of the control tire is assigned a value of 100%, a tire having the present tread can have a normalized rolling resistance coefficient of 95% or less, or 90% or less, or 85% or less, or 80% or less. Alternatively stated, a tire having the present tire tread can have at least 10% decreased normalized rolling resistance compared to a tire tread of equivalent design comprising a comparable loading of carbon black filler.

As described herein, the present tire treads can be prepared from an initial elastomer composite formed by mixing at least one filler with at least one elastomer. This initial composite can be considered an uncured mixture of filler(s) and elastomer(s). The composite formed can be considered a mixture or masterbatch, which can be, as an option, an intermediate product for use in subsequent rubber compounding and one or more vulcanization processes. The composite, prior to the compounding and vulcanization, can also be subjected to additional processes, such as one or more holding steps or further mixing step(s), one or more additional drying steps, one or more extruding steps, one or more calendaring steps, one or more milling steps, one or more granulating steps, one or more baling steps, one or more twin-screw discharge extruding steps, or one or more rubber working steps to obtain a rubber compound or a rubber article.

PCT Publ. No. WO 2020/247663, the disclosure of which is incorporated by reference herein, describes mixing processes with solid elastomer and a wet filler (e.g., comprising a filler and a liquid) to enable the batch time and temperature to be controlled beyond that attainable with known dry mixing processes. As an option, the composite can be prepared by a method comprising:
(a) charging a mixer having one or more rotors with at least a solid elastomer and a wet filler comprising a filler and a liquid present in an amount of at least 15% by weight based on total weight of wet filler; (b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
   (i) the mixer has at least one temperature-control means that is set to a temperature, T_{z}, of 65° C. or higher, and
   (ii) the one or more rotors operate, for at least 50% the mixing time, at a tip speed of at least 0.6 m/s; and
(c) discharging, from the mixer, the composite comprising the filler dispersed in the elastomer at a loading of at least 20 phr comprising least 15 phr of at least one silica, wherein the composite has a liquid content of no more than 10% by weight based on total weight of said composite. The mixing can be performed in one, two, three, or more mixing steps.

As an option, the tire tread comprises an elastomer compound (vulcanizate) prepared by curing a composite in the presence of at least one curing agent, wherein the composite is formed by mixing at least a solid elastomer and a wet filler (e.g., wet silica) comprising a filler and a liquid present in an amount of at least 15% by weight based on total weight of wet filler (e.g., liquid present in an amount of at least 20% at least 30%, at least 40%, or ranging from 15% to 80%, ranging from 20% to 70%, ranging from 30% to 60%, or ranging from 40% to 60% by weight based on total weight of wet filler, e.g., wet silica). The wet filler or wet silica can be in the form of a powder paste, pellet, cake, or slurry. As an option, the mixing of the at least a solid elastomer and wet filler (e.g., wet silica) is performed in a mixer having at least one temperature-control means that is set to a temperature, T_{z}, of 50° C. or higher, or 55° C. or higher, or 60° C. or higher, or 65° C. or higher, or 70° C. or higher and up to 100° C., up to 95° C. or up to 90° C. As an alternative or an additional option, the mixing of the at least a solid elastomer and wet filler (e.g., wet silica) is performed in a mixer with one or more rotors of the mixer operating at a tip speed of at least 0.6 m/s for at least 50% of mixing time.

The composite can be formed by single stage mixing, or multi-stage mixing (e.g., two-stage mixing, three-stage mixing, etc.). The resulting composite discharged from the mixer comprises the filler (e.g., silica) dispersed in the elastomer at a loading of at least 20 phr (comprising at least 15 phr silica) wherein the composite has a liquid content of no more than 10% (e.g., no more than 5%) by weight based on total weight of said composite. Further details of mixing solid elastomer with wet filler are disclosed in PCT Publ. No. WO 2020/247663, the disclosure of which is incorporated by reference herein.

As another option, one or more rotors can be mechanically coupled to a mixer motor and at least a portion of the mixing in step (b) is performed under power control in which the rotational speed of the one or more rotors is controlled by a controller that (i) calculates a difference (e.g., automatically calculates the difference) between a measured mixer motor power and a power set point and (ii) adjusts the rotational speed of the one or more rotors if the measured mixer motor power deviates from the power set point, as described in PCT Publ. No. WO 2023/034575, the disclosure of which is incorporated by reference herein. As a further option, the mixing can be performed under PID power control. The controller can continuously calculate the difference between the measured mixer motor power and the power set point, e.g., at time intervals ranging from 0.05 s to 5 so or from 0.05 s to 1 s. As an option, one or more stages of the mixing (e.g., first and second stages of the mixing) can be performed under power control.

A composite resulting from the mixing of a wet filler with solid elastomer can be termed a wet-mixed composite. As an option, the present tire tread comprises an elastomer compound formed from a wet-mixed composite, having at least one of improved treadwear (e.g., decreased treadwear rate) and rolling resistance performance compared to a control tire tread comprising an elastomer compound formed from a dry-mix equivalent composite. A dry mix equivalent composite has a comparable composition as the wet-mixed composite (e.g., comparable filler, filler loading, elastomer, formulation) except it is formed by known dry mixing methods, e.g., mixing of dry filler and solid elastomer.

Accordingly, as an option, a tire having the present tire tread has improved rolling resistance properties (e.g., a normalized rolling resistance coefficient of 90 or less) compared to a control tire having an equivalent tread in which the control rubber compound was derived or formed from a dry mix equivalent. As another option, the present tire tread has the same or improved wear properties (reduced wear rate) compared to an equivalent tread having a rubber compound formed from or derived from a dry mix equivalent.

Composites used to form the present tire treads can further comprise one or more additives, including anti-degradants (e.g., N-(1,3-dimethylbutyl)-N′-phenyl-p-phenylenediamine or “6PPD” and Antioxidant DQ or “TMQ”), coupling agents, and one or more rubber chemicals to enable dispersion of filler into the elastomer. Rubber chemicals, as defined herein, include one or more of: processing aids (to provide ease in rubber mixing and processing, e.g. various oils and plasticizers, wax), activators (to activate the vulcanization process, e.g. zinc oxide and fatty acids), accelerators (to accelerate the vulcanization process, e.g. N,N′-diphenyl guanidine or “DPG” powder, sulphenamides, and thiazoles), vulcanizing agents (or curatives, to crosslink rubbers, e.g. sulfur, peroxides), and other rubber additives, such as, but not limit to, retarders, co-agents, peptizers, adhesion promoters, tackifiers, resins, flame retardants, colorants, and blowing agents. As an option, the rubber chemicals can comprise processing aids and activators. As another option, the one or more other rubber chemicals are selected from zinc oxide, fatty acids, zinc salts of fatty acids, wax, accelerators, resins, and processing oil.

For a silica filler, if a coupling agent is used, the coupling agent can be introduced in any of the steps (or in multiple steps or locations) of the mixing as long as the coupling agent has an opportunity to become dispersed in the composite. The coupling agent can be or include one or more silane coupling agents, one or more zirconate coupling agents, one or more titanate coupling agents, one or more nitro coupling agents, or any combination thereof. The coupling agent can be or include bis(3-triethoxysilylpropyl) tetrasulfane (e.g., Si 69 from Evonik Industries, Struktol SCA98 from Struktol Company), bis(3-triethoxysilylpropyl)disulfane (e.g., Si 75 and Si 266 from Evonik Industries, Struktol SCA985 from Struktol Company), 3-thiocyanatopropyl-triethoxy silane (e.g., Si 264 from Evonik Industries), gamma-mercaptopropyl-trimethoxy silane (e.g., VP Si 163 from Evonik Industries, Struktol SCA989 from Struktol Company), gamma-mercaptopropyl-triethoxy silane (e.g., VP Si 263 from Evonik Industries), zirconium dineoalkanolatodi (3-mercapto) propionato-O, N,N′-bis(2-methyl-2-nitropropyl)-1,6-diaminohexane, S-(3-(triethoxysilyl) propyl) octanethioate (e.g., NXT coupling agent from Momentive, Friendly, WV), and/or coupling agents that are chemically similar or that have the one or more of the same chemical groups. As an option, the coupling agent is triethoxysilylpropyl) tetrasulfane (Si 69). Additional specific examples of coupling agents, by commercial names, include, but are not limited to, VP Si 363 from Evonik Industries, and NXT Z and NXT Z-50 silanes from Momentive. The coupling agents described herein could be used to provide hydrophobic surface modification of silica (precoupled or pretreated silica) before using it in any of the processes disclosed herein. It is to be appreciated that any combination of elastomers, additives, and additional composite may be added to the elastomer composite, for instance in a compounding step.

The tire tread can be formed by any one of the processes described herein or combinations thereof. Generally, tire treads can be formed from mixing a filler with elastomer to form an elastomer composite, which then can be compounded into a tire tread formulation that is cured to form a rubber compound. The compound can be molded and cured with a desired tread pattern. The treads can be applied to tires and autoclaved to make the completed tire.

The tire tread can be selected from truck-bus-radial (TBR) tire tread, off the road (OTR) tire tread, passenger car tire tread, performance vehicle tire tread, light truck tire tread, motorcycle tire tread, electric vehicle tire tread, aircraft tire tread, and heavy equipment tire tread. The tread can include the cap and base and undertread.

### EXAMPLES

The Examples describe the preparation of composites, compounds (vulcanizates), and tire treads in which performance (treadwear, rolling resistance) is assessed against control treads.

### Example 1

A composite was prepared by mixing wet filler with natural rubber (Composite 1). As a control, comparative carbon black and silica composites were made with traditional dry mixing methods (Comparative CB and Comparative Silica Composites). The elastomers used were TSR20 (Technically Specified Rubber, 0.2% Dirt, max % retained on a 45 μm sieve, and standard grade natural rubber RSS #3. Technical descriptions of these natural rubbers are widely available, such as in Rubber World Magazine's Blue Book published by Lippincott and Peto, Inc. (Akron, Ohio, USA). The carbon black (CB) used was provided as VULCAN® 7H carbon black. Silica used was ZEOSIL® 71165 MP precipitated silica (“Z1165MP”) from Solvay USA Inc., Cranbury, N.J. The silane coupling agents used were, X50S and Si-69 (“Si69”) coupling agent, both from Evonik Industries.

Preparation of wet silica: Dry silica with a moisture content of 7.5 wt. % moisture was fed at a rate of 460 lbs/hr to a continuous FEECO pin mixer. Water was sprayed using two fan nozzles in the pin mixer located just after where the dry silica entered the pin mixer. The water spray rate was 486 lbs/hr. Uniform wet silica pellets between 60 and 120 mesh were discharged with 52.5 wt. % water.

Composite formulations (amounts in phr) are shown in Table 1.

TABLE 1

| | Compar- | Compar- | |
|---|---|---|---|
| | ative CB | ative Silica | Composite 1 |
| NR (TSR20) | 100 | 100 | |
| NR (RSS#3) | | | 100 |
| CB | 50 | | 4 |
| silica wet* | | | 55 |
| (52.5 wt. % moisture) | | | |
| silica dry | | 50 | |
| X50S | | 10 | |
| Si69 | | | 5.5 |
| 6PPD | | | 2 |
| Chemicals | | | |
| Zinc Oxide | 3 | 3 | 3 |
| Stearic Acid | 2 | 2 | 2 |
| 6PPD | 1.5 | 1.5 | 0.5 |
| TMQ | 1.5 | 1.5 | 1.5 |
| LSW 654 (Wax) | 1.5 | 1.5 | 1.5 |
| Zinc Soap | 2 | 2 | |
| DPG | | 0.5 | |

*silica loading reported on dry basis

The comparative composites were prepared by dry mixing and performed in two stages. The stage 1 and 2 protocols for forming the comparative carbon black composites (“Comparative CB Composite”) are shown in Tables 2 and 3, respectively, and the stage 1 and 2 protocols for forming the comparative silica composites (“Comparative Silica Composite”) are shown in Tables 4 and 5, respectively. Both stage 1 and 2 mixing processes were performed with a 320 L intermeshing mixer equipped with PES5 rotors (Harburg Feudenberger GK 320) with a TCU temperature at 40° C.

TABLE 2

| Step | Time (s) | Mixer rpm | Description |
|---|---|---|---|
| 1 | 20 | 30 | Add polymer + chemicals (see Table 1) |
| 2 | 20 | 40 | Mixing |
| 3 | 30 | 40 | Add ⅔ CB |
| 4 | 5 | 40 | Mixing |
| 5 | 35 | 40 | Mixing |
| 6 | 10 | 35 | Ram Sweep |
| 7 | 35 | 35 | Mixing |
| 8 | 10 | 30 | Ram Sweep |
| 9 | 90 | 30 | Mix until temp = 160° C. |
| 10 | 15 | 20 | Dump |

TABLE 3

| Step | Step Time (s) | Mixer rpm | Step |
|---|---|---|---|
| 1 | 20 | 30 | Add Stage 1 Composite |
| 2 | 20 | 30 | Mixing |
| 3 | 30 | 30 | Add ⅓ CB |
| 4 | 5 | 35 | Mixing |
| 5 | 30 | 35 | Mixing |
| 6 | 10 | 30 | Ram Sweep |
| 7 | 30 | 25 | Mixing |
| 8 | 10 | 20 | Ram Sweep |
| 9 | 90 | 20 | Mix until temp = 150° C. |
| 10 | 15 | 20 | Dump |

TABLE 4

| Step | Time (s) | Mixer rpm | Description |
|---|---|---|---|
| 1 | 20 | 30 | Add polymer + chemicals (see Table 1) |
| 2 | 30 | 30 | Mixing |
| 3 | 32 | 30 | Add ⅔ silica |
| 4 | 30 | 30 | Mixing |
| 5 | 25 | 30 | Add silane |
| 6 | 33 | 30 | Add ⅓ silica |
| 7 | 30 | 30 | Mixing |
| 8 | 4 | 30 | Ram sweep |
| 9 | 60 | 30 | Mix until temp = 148° C. |
| 10 | 4 | 30 | Ram sweep |
| 11 | 10 | 30 | Mixing |
| 12 | 120 | 20 | Mixing, hold temperature at 148° C. |
| 13 | 15 | 20 | Dump |

TABLE 5

| | Step | Mixer | Step Temp. | |
|---|---|---|---|---|
| Step | Time (s) | rpm | (° C.) | Description |
| 1 | 20 | 25 | | Add stage 1 composite |
| 2 | 20 | 25 | | Mixing |
| 3 | 30 | 25 | | Mixing |
| 4 | 10 | 25 | | Ram Sweep |
| 5 | 45 | 25 | 130 | Mixing |
| 6 | 10 | 25 | | Ram Sweep |
| 7 | 45 | 25 | 148 | Mixing |
| 8 | 10 | 20 | | Ram Sweep |
| 9 | 15 | 20 | | Mixing |
| 10 | 90 | 20 | 148 | Mixing, hold temperature |
| 11 | 10 | 20 | | Dump |

Composite 1 was formed from the mixing of wet filler with solid elastomer and was conducted in two stages followed by a third stage for adding chemicals. The first stage mixing was performed with a Kobelco BB-16 tangential mixer equipped with 6WI rotors (Kobelco Kobe Steel Group) at a TCU temperature setpoint of 83° C. and a fill factor of 66%. The protocol for first stage mixing is shown in Table 6. At steps 5, 9, and 13, the mixing was performed under power PID control (proportional integral differential). The proportional constant was 200%, the integral constant was 5 s, and no derivative control was used. The power set points (KW) and maximum rotor speed settings are indicated in Table 6. The power input signal used by the power PID control loop was filtered by using a Kalman filter with a K2 constant of 0.005. Additional details on mixing with power PID control and the Kalman filter are provided in PCT Publication No. WO 2023/034575, the disclosure of which is incorporated by reference herein.

TABLE 6

| | | | | Power | |
|---|---|---|---|---|---|
| | Step | Ram | Mixer | Setpoint | |
| Step | Time(s) | Position | rpm | (kW) | Description |
| 1 | 20 | UP | 50 | | Add rubber |
| 2 | 120 max | DN | 60 | | Masticate rubber until earliest of 120 s and |
| | | | | | 110° C. |
| 3 | 20 | UP | 50 | | 1^{st} filler addition (75% of filler) and add silane |
| 4 | 20 | DN | 50 | | Allow ram to seat |
| 5 | 120 max | DN | Power | 75 | Mix under power PID control until earliest of |
| | | | PID | | 120 s and 130 C.; maximum rotor speed to reach |
| | | | | | power setpoint = 85 rpm |
| 6 | 10 | DN | 30 | | Prepare for ram raise |
| 7 | 20 | UP | 40 | | 2^{nd} filler addition (25% of filler) |
| 8 | 20 | DN | 50 | | Allow ram to seat |
| 9 | 148 | DN | Power | 75 | Mix under power PID control until 148° C.; |
| | | | PID | | maximum rotor speed to reach power |
| | | | | | setpoint = 85 rpm |
| 10 | 10 | DN | 30 | | Prepare for ram raise |
| 11 | 20 | UP | 40 | | Add 6PPD |
| 12 | 20 | DN | 50 | | Allow ram to seat |
| 13 | 20 | DN | Power | 100 | Mix under power PID control for 20 s; maximum |
| | | | PID | | rotor speed to reach power setpoint = 100 rpm |
| 14 | Variable | DN | 100 | 100 | Mix until 150 C.; maximum rotor speed to reach |
| | | | | | power setpoint = 100 rpm |
| 15 | Variable | DN | 100 | 100 | 30 s after power minimum, where power is |
| | | | | | greater than 90 kW; maximum rotor speed to |
| | | | | | reach power setpoint = 100 rpm |
| 16 | 30 | DN | 50 | | Dump |

The composite was processed in a TSR-125 twin-screw discharger extruder fitted with stationary knives (Kobelco Kobe Steel Group).

Second stage mixing to prepare Composite 1 was performed with a BB-72 tangential mixer equipped with 6WI rotors (Kobelco Kobe Steel Group) at a TCU temperature setpoint of 75° C. and a fill factor of 40%. The protocol for second stage mixing is shown in Table 7. After initial mastication with the ram down, mixing was performed under PID temperature control with the ram raised, which allows automated control of the batch temperature via a feedback loop. A thermocouple inserted through the mixer drop door measures the batch temperature, which is transmitted to the PID controller. The output of the controller is used to control the speed of the mixer rotors.

TABLE 7

| | Step | Ram | Mixer | |
|---|---|---|---|---|
| Step | Time (s) | Position | rpm | Description |
| 1 | 30 | UP | 35 | Add 1^{st} stage composite |
| 2 | 30 | DN | 35 | Masticate with ram down |
| 3 | 30 | UP | 35 | Masticate at fixed speed with ram raised |
| 4 | Variable | UP | Variable | Masticate under PID temperature control with ram raised. |
| | | | | Speed automatically varied to maintain temperature target |
| | | | | for step duration.; maximum rotor speed to reach power |
| | | | | setpoint = 70 rpm |
| 5 | 30 | UP | 30 | Dump |

The composite was passed through a TSR-125 twin-screw discharge extruder fitted with a roller-head (Kobelco Kobe Steel Group). The third mixing stage to add the chemicals was performed with a 320 L intermeshing mixer equipped with PES5 rotors (Harburg Feudenberger GK 320) at a TCU setpoint of 40° C. The protocol is shown in Table 8.

TABLE 8

| | Step | Temp | Mixer | |
|---|---|---|---|---|
| Step | Time (s) | (° C.) | rpm | Description |
| 1 | 20 | | 20 | Add 1/2 2^{nd} stage composite |
| 2 | 30 | | 20 | Mixing |
| 3 | 25 | | 20 | Add ½ 2^{nd} stage composite |
| 4 | 45 | | 25 | Mixing |
| 5 | 26 | | 25 | Add chemicals (see Table 1) |
| 6 | 30 | | 30 | Mixing |
| 7 | 4 | | 30 | Ram Sweep |
| 8 | | 130 | 30 | Mixing |
| 9 | 60 | 145 | 20 | Mixing, hold temperature |
| 10 | 15 | | 20 | Dump |

### Compounds (Vulcanizates)

Comparative carbon black and silica vulcanizates (prepared from Comparative CB Composite and Comparative Silica Composite, respectively) and Compound 1 (prepared from Composite 1) were prepared. All of the compounding was performed with a 320 L intermeshing mixer equipped with PES5 rotors (Harburg Feudenberger GK 320) at a TCU setpoint of 40° C.

The compound formulations are shown in Table 9 (amounts in phr), in which the comparative CB and silica compounds were prepared from the dry mixed comparative composites and Compound 1 was prepared from Composite 1. TBBS=Accelerator BBTS and TBzTD=Acccelerator TBzTD, and CTP=Retarder CTP, all available from Akrochem, Akron, Ohio.

TABLE 9

| | Comparative | Comparative | Compound |
|---|---|---|---|
| | CB | Silica | 1 |
| Composite | 161.5 | 172 | 174 |
| DPG | | | 0.5 |
| Sulfur | 1.2 | 1.6 | 1.6 |
| TBBS | 1.4 | 1.95 | 2 |
| TBzTD | | 0.07 | |
| CTP (PVI) | 0.2 | 0.2 | 0.2 |
| Final TOTAL, phr | 164.3 | 175.82 | 178.3 |

The compounding protocol to prepare the Comparative CB Compound is shown in Table 10.

TABLE 10

| Number | Step Time (s) | Mixer rpm | Step |
|---|---|---|---|
| 1 | 20 | 20 | Add Comparative CB |
| | | | Composite and curatives |
| 2 | 60 | 20 | Mixing |
| 3 | 30 | 20 | Mixing |
| 4 | 10 | 18 | Ram Sweep |
| 5 | 35 | 18 | Mixing |
| 6 | 10 | 18 | Ram Sweep |
| 7 | 60 | 18 | Mix until Temp = 125° C. |
| 8 | 15 | 18 | Dump |

The compounding protocol to prepare the Comparative Silica Compound is shown in Table 11.

TABLE 11

| Step | Step Time (s) | Mixer rpm | Description |
|---|---|---|---|
| 1 | 20 | 20 | Add Comparative Silica |
| | | | Composite and curatives |
| 2 | 20 | 20 | Mixing |
| 3 | 20 | 20 | Mixing |
| 4 | 8 | 20 | Ram Sweep |
| 5 | 20 | 20 | Mixing |
| 6 | 4 | 20 | Ram Sweep |
| 7 | 45 | 20 | Mix until Temp = 110° C. |
| 8 | 20 | 20 | Dump |

Protocols for 1st and 2nd stage compounding to prepare Compound 1 are shown in Tables 12 and 13.

TABLE 12

| | Step | Mixer | |
|---|---|---|---|
| Step | Time (s) | rpm | Description |
| 1 | 20 | 20 | Add Composite 1 |
| 2 | 20 | 20 | Mixing |
| 3 | 4 | 20 | Ram Sweep |
| 4 | 45 | 20 | Mixing |
| 5 | 4 | 20 | Ram Sweep |
| 6 | 180 | 20 | Mix until Temp = 140° C. |
| 7 | 15 | 20 | Dump |

TABLE 13

| Step | Step Time (s) | Mixer rpm | Description |
|---|---|---|---|
| 1 | 20 | 20 | Add 1^{st} stage compound |
| | | | (Table 12) and curatives |
| 2 | 20 | 20 | Mixing |
| 3 | 20 | 20 | Mixing |
| 4 | 8 | 20 | Ram Sweep |
| 5 | 20 | 20 | Mixing |
| 6 | 4 | 20 | Ram Sweep |
| 7 | 45 | 20 | Mix until Temp = 120° C. |
| 8 | 20 | 20 | Dump |

Curing of samples was carried out in a heated press (150° C.) for a time determined by a conventional rubber rheometer, e.g., T90+50% of T90, where T90 is the time to achieve 90% vulcanization (pressure=2500 lbs).

### Tire Treads

A re-treading process with pre-cure treads was used to build the tires (tire size: 315/70R22.5). Tires were built and cured by standard techniques known in the art including the following steps: (1) used commercial tires were buffed to remove the tread compound; (2) rubber compound was extruded to camelbacks and molded and cured at 170° C., 230 bar with a lug tread pattern (final pressure removal=15 min., cure time ranged from 19.2 to 21.7 min.); (3) pre-cured treads were buffed, sprayed with a rubber cement; and (4) a cushion gum compound was applied to the buffed tires and the treads were placed on top of the cushion gum and autoclaved to make the completed tire. The tread pattern is a lug type design with an aggressive shoulder and good block stability. The tread depth was 20 mm.

### Defect Concentrations

Total defect concentration observed in the tire treads was determined from the following defect types larger than 2 μm: undispersed carbon black particles, undispersed silica, zinc oxide, and voids. These defects can be identified and quantified from a combination of transmission light microscopy (TLM) images and scanning electron microscopy (SEM) images of thin rubber microtome slices.

Thin microtome rubber slices were made using following procedure. A piece of rubber tire tread was trimmed and mounted in a sample holder. A rubber sample was mounted on an ultra-microtome instrument and cooled to temperatures ranging from −100° C. to −130° C. Rubber slices were then cut at a thickness setting of 1 μm by using an RMC Boeckeler PowerTome ultra-microtome instrument with a diamond knife at −50° C. Each slice was floated off the knife edge into a trough containing a viscous liquid mixture of 60/40 DMSO/water held at −−50° C. The resulting ribbons of cut sections were then transferred to an ITO coated glass slide. Typically, 30 to 40 rubber slices were collected for one sample and the slices are dried at room temperature before imaging. Rubber samples were collected from the geometric center of the tread block in both the radial direction (half of the tread depth, or 10 mm+/−1 mm) and lateral direction (middle of lateral cross-section at half tread depth).

An Olympus optical microscope was used for acquiring transmission light microscopy (TLM) images of the rubber slices by using an image pixel size of 0.645 μm/pixel and a total number of 1360×1024 pixels with the field of view of 0.877 mm×0.660 mm. Typically, only a single image was collected on one rubber slice with a total of 20 to 40 images collected for one sample. A typical TLM image has a gray background with both dark and bright objects. The dark objects are due to undispersed CB particles because of high light extinction coefficient of carbon black, and the bright objects are due to voids in the rubber.

A Zeiss scanning electron microscope (SEM) was used to acquire SEM images of the rubber slices on the ITO glass slide using a back scattering electron (BSE) detector at electron accelerating voltage of 10 kV. The SEM image was collected using a pixel size of 0.456 μm/pixel and 2048×1536 pixels with the field of view 0.933 mm×0.700 mm. The light grey objects in the SEM images are due to undispersed silica and zinc oxide particles.

The TLM images and SEM images were analyzed with a suitable software programs based on the macro language of the NIH ImageJ and Excel macros based on Microsoft Visual Basic for Applications (VBA). The distributions of undispersed carbon black particles and voids were obtained from analysis of the TLM images, while the distributions of undispersed silica and zinc oxide particles are measured using the SEM images. The total defect distribution is obtained by combining the distributions of undispersed carbon black particles, undispersed silica and zinc oxide particles, and voids.

The TLM images were processed by first correcting the uneven background of the image with a pseudo flat-field correction algorithm based on Gaussian blur. The image noises are reduced using an edge-preserving bilateral filter and the image contrast enhancement is applied when needed. The objects were separated from the image with segmentation of the image by using a suitable combination of global and local thresholding method, which created two binary images representing the particles and voids, respectively. Image filtering and segmentation were optimized to ensure that the boundaries of the voids and particles were well defined by visual comparisons between the segmented images and the original images. The SEM images were processed and analyzed similarly to the TLM images, which generated a binary image of undispersed silica and zinc oxide particles. Both the area weighted and number weighted size distributions of the undispersed carbon black, the undispersed silica and zinc oxide particles, and the voids were then analyzed and calculated from their respective binary images.

The particle size was determined from the area equivalent circle diameter of the corresponding object in the binary image, where area equivalent diameter is:

$$Area Equivalent Diameter = {( 4 * Area of Dark objects / π )}^{1 / 2}$$

The smallest area equivalent diameter that can be reliably quantified is 2 μm. Both number weighted distribution and area weighted distribution of the defects were calculated. The absolute number of particles per unit image area as well as percentage of the areas of particles in the image were computed.

Total defect concentration (defects from undispersed carbon black, undispersed silica, ZnO, and voids) based on minimum size in μm, (e.g., at least 2 μm, at least 3 μm, at least 4 μm, at least 5 μm, at least 6 μm, and at least 10 μm) was obtained on a number of commercial tire treads as well as well as the pre-cured treads made from the Comparative CB and Silica compounds and Compound 1 (Comparative CB Tread, Comparative Silica Tread, and Tread 1, respectively). Commercial tire treads analyzed were: Bridgestone® R284 ECOPIA™ tire (“R284”), Firestone® FS 561™ tire (“FS 561”), Goodyear Endurance® LHS® tire (“LHS”), Michelin® X® Line Energy tire (“XLE”), Michelin X® LINE™ ENERGY™ D2 tire (“XLE D2”), Michelin X® LINE™ ENERGY™ 72 tire (“XLE Z2”), Bridgestone ECOPIA H-STEER 002 tire (“H-Steer”), Bridgestone ECOPIA H-DRIVE 002 (“H-Drive”) tire, Goodyear FUELMAX PERFORMANCE S tire (“FM S”), Goodyear FUELMAX PERFORMANCE D tire (“FM D”), and Continental Conti EfficientPro D tire (“PRO D”). The R284, FS 561, and LHS treads are carbon black-based treads. The remaining treads contain a blend of silica and carbon black fillers having silica: carbon black ratios of 1:5 (PRO D, XLE), 1:2 (H-Drive), 5:1 (H-Steer), 6.7:1 (XLE D2), 11.5:1 (XLE Z2, FM S), and 15.7:1 (FM D). All commercial tires have a filler loading of 47-60 phr with the exception of XLE (40 phr). It is noted that the H-Steer, Pro D, H-Drive, XLE D2, and XLE Z2 treads were sampled at 2-3 mm below the tread surface; it is believed that the number of defects would be even greater if sampled at the geometric center.

Total defects by area percent and number percent are listed in Table 14; Table 15 lists corresponding voids data.

TABLE 14

| | | | | | | | Total defects by number density: | | | | | |
|---|---|---|---|---|---|---|---|---|---|---|---|---|
| | Total defects by area % (A_{T}) | | | | | | #/(mm² μm) (N_{T}) | | | | | |
| Tread | 2 μm | 3 μm | 4 μm | 5 μm | 6 μm | 10 μm | 2 μm | 3 μm | 4 μm | 5 μm | 6 μm | 10 μm |
| R284 | 7.2 | 5.8 | 3.7 | 1.9 | 1.5 | 1 | 6738 | 3629 | 1488 | 355 | 141 | 39 |
| FS 561 | 6.5 | 5 | 2.9 | 1.8 | 1.4 | 0.66 | 6444 | 3337 | 1016 | 392 | 199 | 32 |
| LHS | 8 | 5.6 | 2.8 | 1.5 | 1.1 | 0.63 | 9047 | 4240 | 1187 | 296 | 117 | 21 |
| XLE | 7.7 | 7.2 | 6.8 | 6 | 5.4 | 2.7 | 3131 | 2033 | 1392 | 1063 | 782 | 181 |
| H-Steer | 4.7 | 3.3 | 2.1 | 1.2 | 0.84 | 0.25 | 5066 | 2199 | 845 | 332 | 160 | |
| PRO D | 6.0 | 5.1 | 4.2 | 3.1 | 1.9 | 0.26 | 5061 | 2660 | 1621 | 924 | 450 | |
| H-Drive | 3.0 | 1.5 | 0.82 | 0.56 | 0.46 | 0.24 | 4367 | 1004 | 293 | 126 | 69 | |
| XLE D2 | 3.0 | 2.1 | 1.5 | 1.0 | 0.77 | 0.34 | 3140 | 1160 | 511 | 237 | 123 | |
| XLE Z2 | 3.6 | 2.8 | 2.2 | 1.7 | 1.3 | 0.59 | 3093 | 1341 | 678 | 366 | 207 | |
| FM D | 3.2 | 2.0 | 1.2 | 0.67 | 0.39 | 0.22 | 4178 | 1378 | 510 | 201 | 81 | |
| FM S | 2.8 | 1.6 | 0.93 | 0.56 | 0.36 | 0.27 | 3831 | 1145 | 383 | 144 | 60 | |
| Comparative CB | 7.2 | 4.2 | 1.9 | 0.97 | 0.88 | 0.41 | 9512 | 3413 | 844 | 208 | 75 | 15 |
| Comparative Silica | 3.6 | 3.4 | 3.1 | 2.6 | 2.2 | 0.41 | 1786 | 1231 | 900 | 642 | 427 | 39 |
| Tread 1 | 0.79 | 0.62 | 0.49 | 0.36 | 0.31 | 0.097 | 748 | 280 | 130 | 69 | 43 | 9.4 |

TABLE 15

| | | | | | | | Voids by number density: | | | | | |
|---|---|---|---|---|---|---|---|---|---|---|---|---|
| | Voids by area % (A_{V}) | | | | | | #/(mm² μm) (N_{V}) | | | | | |
| Tread | 2 μm | 3 μm | 4 μm | 5 μm | 6 μm | 10 μm | 2 μm | 3 μm | 4 μm | 5 μm | 6 μm | 10 μm |
| R284 | 4.8 | 4.0 | 2.4 | 0.79 | 0.37 | 0.11 | 4633 | 2920 | 1314 | 254 | 65 | 5.8 |
| FS 561 | 4.1 | 3.1 | 1.4 | 0.76 | 0.49 | 0.13 | 4429 | 2421 | 649 | 204 | 97 | 7.8 |
| LHS | 6.1 | 4.4 | 1.9 | 0.76 | 0.39 | 0.13 | 6939 | 3605 | 1030 | 219 | 66 | 6.5 |
| XLE | 4.2 | 3.9 | 3.6 | 3.3 | 3.0 | 1.7 | 1759 | 1054 | 715 | 541 | 406 | 127 |
| H-Steer | 1.2 | 0.80 | | | | | 3516 | 1691 | | | | |
| PRO D | 0.91 | 0.49 | | | | | 2374 | 1840 | | | | |
| H-Drive | 0.65 | 0.50 | | | | | 1463 | 409 | | | | |
| XLE D2 | 1.1 | 0.78 | | | | | 1273 | 319 | | | | |
| XLE Z2 | 0.73 | 0.41 | | | | | 509 | 176 | | | | |
| FM D | 1.2 | 0.80 | | | | | 1224 | 549 | | | | |
| FM S | 0.91 | 0.49 | | | | | 1007 | 308 | | | | |
| Comparative CB | 6.0 | 3.5 | 1.4 | 0.61 | 0.36 | 0.15 | 8026 | 1983 | 737 | 161 | 55 | 8 |
| Comparative Silica | 2.7 | 2.6 | 2.5 | 2.3 | 2.0 | 0.39 | 1038 | 774 | 634 | 507 | 384 | 38 |
| Tread 1 | 0.36 | 0.25 | 0.20 | 0.16 | 0.13 | 0.055 | 362 | 118 | 56 | 32 | 21 | 4.2 |

From Tables 14 and 15, it can be seen that the comparative treads had similar defect concentrations to other commercially available tires on the market. In contrast, the exemplary tread disclosed herein (Tread 1) has noticeably lower total defect and voids concentrations compared to the commercial and comparative tire treads for a wide array of defect sizes (ranging from at least 2 μm to at least 10 μm).

### Treadwear and Rolling Resistance

Treadwear tests were carried out with the completed tires on vehicles transporting goods within Europe in a regional/long haul application. The modern lorries used in the test have a 4×4 axle configuration with a single trailer delivering goods in Western Europe and the tires were evaluated for wear rates in the drive position. Tread depth measurements were measured every two months until the tires were removed from service. A total of 28 tires were measured for tread depth loss for the Comparative CB (14 tires) and Tire 1 (14 tires). The results are shown with an index by the following equation, Normalized Tread depth loss per distance traveled=(Tread depth loss per distance traveled of the example)/tread depth loss per distance traveled for the Comparative CB tire)×100. The results indicate that the smaller the index, the lower the wear rate and the longer tire life. The tires tested were prepared from the Comparative CB tread (Comparative CB tire) and Tread 1 (Tire 1).

A rolling resistance test was completed in accordance with DIN ECE R 117 Annex 6. Data for rolling resistance and treadwear performance is shown in Table 16.

TABLE 16

| | Rolling | Normalized Tread depth |
|---|---|---|
| | resistance | loss per distance traveled |
| Tire | (N/kN) | (%) |
| Comparative CB | 7.37 | 100 |
| Tire 1 | 5.82 | 93 |

From Table 16, it can be seen that wear performance of Tire 1, containing Tread 1, outperformed the Comparative CB control tire. This is a surprising result in that treadwear rate of silica containing TBR tires are generally believed to be inferior to treads made from carbon black-based compounds. It can be hypothesized that a low defect concentration in the tire tread has an effect on improved treadwear performance for silica-containing tread compounds.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A tire tread comprising at least one elastomer and at least 15 phr silica, wherein the tread has a low total defect concentration indicated by a value A_{T}, defined as an area percentage of defects in a 1 μm thick tread slice, satisfying at least one of (i) to (vi):
(i) A_{T}≤2.7% for defects having an area-equivalent diameter of at least 2 μm;
(ii) A_{T}≤1.4% for defects having an area-equivalent diameter of at least 3 μm;
(iii) A_{T}≤0.75% for defects having an area-equivalent diameter of at least 4 μm;
(iv) A_{T}≤0.5% for defects having an area-equivalent diameter of at least 5 μm;
(v) A_{T}≤0.33% for defects having an area-equivalent diameter of at least 6 μm; and
(vi) A_{T}≤0.15% for defects having an area-equivalent diameter of at least 10 μm.

2. The tire tread of claim 1, wherein A_{T}≤2.5% for defects having an area-equivalent diameter of at least 2 μm.

3. The tire tread of claim 1, wherein A_{T}≤1% for defects having an area-equivalent diameter of at least 3 μm.

4. The tire tread of claim 1, wherein A_{T} ≤0.6% for defects having an area-equivalent diameter of at least 4 μm.

5. The tire tread of claim 1, wherein A_{T}≤0.4% for defects having an area-equivalent diameter of at least 5 μm.

6. A tire tread comprising at least one elastomer and at least 15 phr silica, wherein the tread has a low total defect concentration as indicated by the equation
$${A}_{T} \leq a \cdot {e}^{- bx} + c$$
wherein x=silica loading (phr) and Ar is an area percentage of defects in a 1 μm thick tread slice and satisfies at least one of (i) to (v):
(i) a=4, b=0.08, and c=1.9 for defects having an area-equivalent diameter of at least 2 μm;
(ii) a=2.4, b=0.07, and c=1 for defects having an area-equivalent diameter of at least 3 μm;
(iii) a=0.8, b=0.008, and c=0.09 for defects having an area-equivalent diameter of at least 4 μm;
(iv) a=−0.73, b=0.15, and c=0.93 for defects having an area-equivalent diameter of at least 5 μm; and
(v) a=−5.26, b=0.001, and c=5.38 for defects having an area-equivalent diameter of at least 6 μm.

7. (canceled)

8. A tire tread comprising at least one elastomer and at least 15 phr of silica wherein the tread has a low total defect concentration indicated by a value N_{T}, defined as number of defects per area in a 1 μm thick tread slice, satisfying at least one of (i) to (vi):
(i) N_{T}≤1700/mm² for defects having an area-equivalent diameter of at least 2 μm;
(ii) N_{T}≤950/mm² for defects having an area-equivalent diameter of at least 3 μm;
(iii) N_{T}≤250/mm² for defects having an area-equivalent diameter of at least 4 μm;
(iv) N_{T}≤100/mm² for defects having an area-equivalent diameter of at least 5 μm; and
(v) N_{T}≤50/mm² for defects having an area-equivalent diameter of at least 6 μm.

9.-12. (canceled)

13. A tire tread comprising at least one elastomer and at least 15 phr silica, wherein the tread has a low total defect concentration as indicated by the equation
$${N}_{T} \leq a \cdot {e}^{- bx} + c$$
wherein x=silica loading (phr) and N_{T} is a number of defects per area in a 1 μm thick tread slice and satisfies at least one of (i) to (v):
(i) a=2500, b=0.007, and c=0 for defects having an area-equivalent diameter of at least 2 μm;
(ii) a=1500, b=0.018, and c=0 for defects having an area-equivalent diameter of at least 3 μm;
(iii) a=580, b=0.14, and c=240 for defects having an area-equivalent diameter of at least 4 μm;
(iv) a=−30, b=0.01, and c=120 for defects having an area-equivalent diameter of at least 5 μm; and
(v) a=−590, b=0.0014, and c=611 for defects having an area-equivalent diameter of at least 6 μm.

14.-17. (canceled)

18. A tire tread comprising at least one elastomer and at least 15 phr of at least one silica, wherein the tread has a low voids concentration indicated by a value A_{V}, defined as an area percentage of voids in a 1 μm thick tread slice, satisfying at least one of (i) and (ii):
(i) A_{V}≤0.6% for voids having an area-equivalent diameter of at least 2 μm; and
(ii) A_{V}≤0.4% for voids having an area-equivalent diameter of at least 3 μm.

19. (canceled)

20. (canceled)

21. A tire tread comprising at least one elastomer and at least 15 phr silica, wherein the tread has a low voids concentration as indicated by the equation
$${A}_{V} \leq a \cdot {e}^{- bx} + c$$
wherein x=silica loading (phr) and Av is an area percentage of voids in a 1 μm thick tread slice and satisfies at least one of (i) and (ii):
(i) a=3.3, b=0.037, and c=0.1 for voids having an area-equivalent diameter of at least 2 μm; and
(ii) a=2.3, b=0.075, and c=0.28 for voids having an area-equivalent diameter of at least 3 μm.

22. (canceled)

23. A tire tread comprising at least one elastomer and at least 15 phr of at least one silica, wherein the tread has a low voids concentration indicated by a value N_{V}, defined as number of voids per area in a 1 μm thick tread slice, satisfying at least one of (i) to (iii):
(i) N_{V}≤500/mm² for voids having an area-equivalent diameter of at least 2 μm;
(ii) NV ≤150/mm² for voids having an area-equivalent diameter of at least 3 μm; and
(iii) NV ≤65/mm² for voids having an area-equivalent diameter of at least 4 μm.

24. (canceled)

25. (canceled)

26. A tire tread comprising at least one elastomer and at least 15 phr silica, wherein the tread has a low voids concentration as indicated by the equation
$${N}_{V} \leq a \cdot {e}^{- bx} + c$$
wherein x=silica loading (phr) and Ny is a number of voids per area in a 1 μm thick tread slice and satisfies at least one of (i) and (ii):
(i) a=800, b=0.02, and c=400 for voids having an area-equivalent diameter of at least 2 μm; and
(ii) a=480, b=0.1, and c=170 for voids having an area-equivalent diameter of at least 3 μm.

27. (canceled)

28. (canceled)

29. The tire tread of claim 1, wherein
the silica is present in an amount ranging from 15 phr to 200 phr.

30. (canceled)

31. The tire tread of claim 1, wherein the silica is precipitated silica.

32. The tire tread of claim 1, wherein the silica is rice husk silica.

33. The tire tread of claim 1, wherein the silica has a CTAB surface area ranging from 80 m²/g to 350 m²/g.

34. (canceled)

35. The tire tread of claim 1, wherein the tire tread further comprises at least one additional filler selected from carbonaceous materials, carbon black, nanocellulose, lignin, clays, nanoclays, metal oxides, metal carbonates, pyrolysis carbon, reclaimed carbon, recovered carbon black, graphenes, graphene oxides, reduced graphene oxide, densified reduced graphene oxide granules, carbon nanotubes, single-wall carbon nanotubes, multi-wall carbon nanotubes, carbon nanostructures, fibrous fillers, hydrothermal carbon, nanocrystalline cellulose starch particles, polysaccharides, glucans, dextrans, microfibrillated cellulose, starch, siliceous earth, crumb rubber, and functionalized crumb rubber, or combinations thereof, and coated and treated materials thereof.

36. The tire tread of claim 35, wherein silica is present in an amount ranging from 25% to 99% by weight and the at least one additional filler is present in an amount ranging from 1% to 75% by weight relative to the total weight of filler.

37. The tire tread of claim 35, wherein the at least one additional filler is carbon black.

38. The tire tread of claim 37, wherein a total filler loading ranges from 30 phr to 100 phr and the silica is present in an amount ranging from 30 phr to 99 phr and carbon black is present in an amount ranging from 1 phr to 30 phr.

39. The tire tread of claim 37, wherein a total filler loading is 80 phr and the silica is present in an amount ranging from 15 phr to 30 phr and carbon black is present in an amount ranging from 20 phr to 40 phr.

40. The tire tread of claim 1, wherein the tread has a thickness ranging from 4 mm to 150 mm.

41. The tire tread of claim 1, wherein the at least one elastomer is selected from natural rubber, functionalized natural rubber, styrene-butadiene rubber, functionalized styrene-butadiene rubber, hydrogenated styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, thermoplastic block copolymers, and blends thereof.

42. The tire tread of claim 1, wherein the at least one elastomer is selected from natural rubber, styrene-butadiene rubber, polybutadiene rubber, and blends thereof.

43. The tire tread of claim 1, wherein the at least one elastomer comprises natural rubber in an amount of at least 20% by weight relative to the total weight of the elastomer.

44. The tire tread of claim 1, wherein the at least one elastomer comprises natural rubber in an amount of at least 50% by weight relative to the total weight of the elastomer.

45. The tire tread of claim 1, wherein the at least one elastomer is natural rubber.

46. The tire tread of claim 1, wherein the at least one elastomer is a blend comprising natural rubber and at least one of styrene-butadiene rubber and polybutadiene rubber.

47. The tire tread of claim 1, wherein the at least one elastomer comprises styrene-butadiene rubber and polybutadiene rubber.

48. The tire tread of claim 47, wherein the at least one elastomer further comprises natural rubber in an amount ranging from 0.1% to 10% by weight relative to the total weight of the at least one elastomer.

49. The tire tread of claim 1, wherein the tire tread is selected from truck-bus-radial (TBR) tire tread, off the road (OTR) tire tread, passenger car tire tread, performance vehicle tire tread, light truck tire tread, motorcycle tire tread, electric vehicle tire tread, and heavy equipment tire tread.

50. The tire tread of claim 1, wherein the tire tread is selected from truck-bus-radial (TBR) tire tread.

51. The tire tread of claim 1, wherein the tire tread is derived from a composite formed from mixing the silica as a wet silica with the at least one elastomer as a solid elastomer.

52. A tire having the tread of claim 1.

53. A tire having the tread of claim 1, wherein the tire has a rolling resistance coefficient of 7 N/kN RRc or less.

54. A tire having the tread of claim 1, wherein the tire has a normalized rolling resistance coefficient of 95 or less.

55. A tire having the tread of claim 1, wherein the tire has 10% decreased normalized rolling resistance compared to a tire tread of equivalent design having a comparable loading of carbon black filler.

56. A tire having the tread of claim 1, wherein the tire has equivalent or decreased treadwear rate compared to a tire tread of equivalent design having a comparable loading of carbon black filler.

57. A tire having the tread of claim 1, wherein the tire has 10% decreased normalized rolling resistance compared to a tire tread derived from a dry mix equivalent prepared from a dry filler and solid elastomer.

58. A tire having the tread of claim 1, wherein the tire has equivalent or decreased treadwear rate compared to a tire tread derived from a dry mix equivalent prepared from a dry filler and solid elastomer.
